(19) United States
(12) Patent Application Publication
(10) Pub. No.: US 2026/0333537 A1
(43) Pub. Date: Oct. 22, 2026

(54) LED DRIVER WITH COLOR DRIFT COMPENSATION AND ENHANCED OUTPUT CURRENT CAPABILITY

(71) Applicant: Infineon Technologies AG, Neubiberg (DE)

(72) Inventors: Stefano Lissandron, Vigodarzere (IT); Fausto Borghetti, Sant'Ambrogiodi Valpolicella (VR) (IT); Gabriele Borella, Padova (IT)

(21) Appl. No.: 19/637,948

(22) Filed: Apr. 2, 2026

(30) Foreign Application Priority Data
Apr. 22, 2025 (DE) 102025115498.8

(51) Int. Cl. H05B 45/24; H05B 45/325; H05B 45/345; H05B 45/50; H05B 47/155

(52) U.S. Cl. CPC H05B 45/24; H05B 45/325; H05B 45/345; H05B 45/50; H05B 47/155

(57) ABSTRACT

A circuit for driving LED lighting devices is described herein. In one embodiment, the circuit includes a first lighting device including at least one LED; a first current detection device; a LED driver having a first output terminal coupled to the lighting device via the first current detection device and configured to provide an output current; and a current amplifier circuit coupled to the first lighting device and to the first current detection device and configured to provide a first current, which adds to the output current so that a load current of the first lighting device is the superposition of the output current and the first current.

### TECHNICAL FIELD

The present disclosure relates to the field of driver circuits for driving Light Emitting Diodes (LEDs).

### BACKGROUND

Lighting devices often include LEDs because these are more efficient than conventional illuminants. However, LEDs usually require a regulated load current, which is provided by dedicated LED driver circuits. LED drivers commonly provide a pulse width modulated load current to a LED or a series circuit of two or more LEDs (LED chain). Many lighting devices include three LEDs (or LED chains) emitting red, green and blue light, respectively. These three colors may additively mix to form white light or any other color (hue). The actual color tone, however, depends on the current of the individual LEDs, wherein LED drivers may be capable of controlling the color tone based on the forward voltages of the LEDs.

Many known LED drivers have limited output current capabilities and using separate current amplifier may prevent the LED driver from utilizing the color control function. Accordingly, there is a need for an improved concept for driving LEDs with load currents that exceed the maximum output current of a conventional LED driver.

### SUMMARY

A circuit for driving LED lighting devices is described herein. In one embodiment, the circuit includes a first lighting device including at least one LED; a first current detection device; a LED driver having a first output terminal coupled to the lighting device via the first current detection device and configured to provide an output current; and a current amplifier circuit coupled to the first lighting device and to the first current detection device and configured to provide a first current, which adds to the output current so that a load current of the first lighting device is the superposition of the output current and the first current.

In accordance with another embodiment, the circuit includes a first lighting device including at least one LED; a first current measurement resistor; a LED driver having a first output terminal coupled to the lighting device via the first current measurement resistor and configured to provide an output current; and a current amplifier circuit coupled to the first lighting device and to the first current measurement resistor and configured to provide a load current of the first lighting device that is proportional to the output current.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 illustrates an example of a three-channel LED driver for driving a lighting device that includes three LEDs chains emitting light of different color.

FIG. 2 illustrates one exemplary embodiment of a circuit including a LED driver for driving a lighting device and a current amplifier circuit for increasing the load current of the lighting device.

FIG. 3 illustrates one implementation of the example of FIG. 2 in more detail.

FIG. 4 illustrates an exemplary implementation of the example of FIG. 3 in more detail.

FIG. 5 illustrates an enhancement of the circuit of FIG. 4.

### DETAILED DESCRIPTION

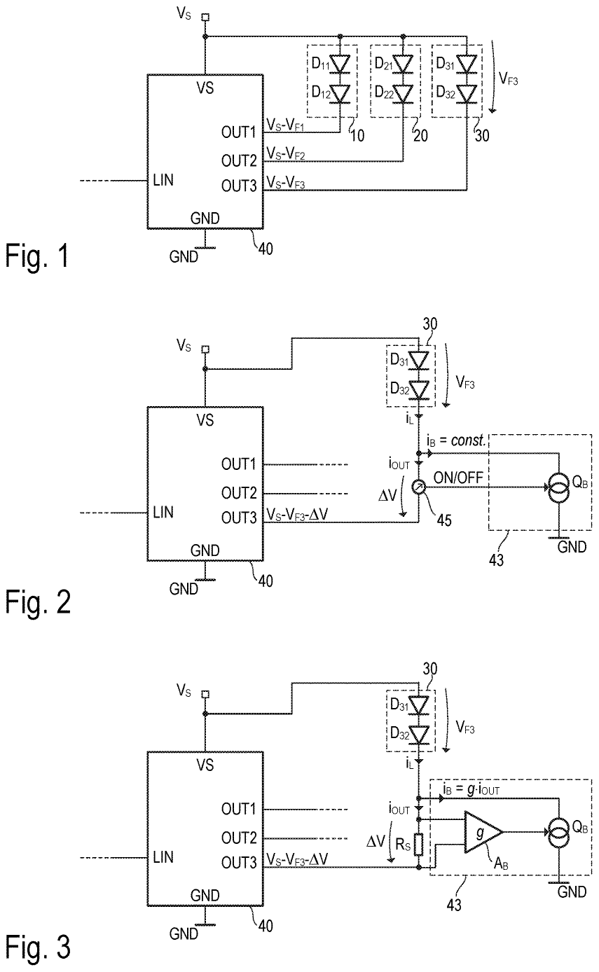

FIG. 1 illustrates an example of a three-channel LED driver 40 for driving a lighting device that includes three LEDs chains 10, 20, and 30. These led chains emit light of different color, e.g. red, green and blue to form white light. It is understood that the concepts described herein are not limited to lighting devices emitting white light. Other colors may be generated by mixing the light of two or more (often three) different LEDs. In the depicted example the LED driver 40 receives a supply voltage V_{S} at a supply node VS. A ground node GND of the LED driver 40 is coupled to ground potential (or any other reference potential). In the depicted example, the LED driver 40 includes a Local Interconnect Network (LIN) interface which allows the LED driver to digitally communicate with other circuits. Of course, any other communication interface may be used instead of LIN. Some examples may use a plurality of digital input and output nodes (I/O pins) to digitally communicate with other circuits.

The three output channels include output nodes OUT1, OUT2 and OUT3, which are connected to the LED chains 10, 20 and 30, respectively. The LED driver 40 is configured to generate a load current for the LED chains 10, 20 and 30. In the depicted example, the LED chains 10, 20 and 30 are connected between a supply line, at which the supply voltage V_{S} is provided, and the output nodes OUT1, OUT2, and OUT3, respectively, and the LED driver 40 sinks the load currents of the LED chains. The LED driver 40 may be configured to sense the voltages V_{S}-V_{F1}, V_{S}-V_{F2}, and V_{S}-V_{F3}, wherein V_{F1}, V_{F2}, and V_{F3} are the forward voltages of the LED chains 10, 20, and 30, respectively. The LED driver 40 may be further configured to control the load currents of the LED chains 10, 20, and 30 based on the measured voltages V_{F1}, V_{F2}, and V_{F3} in order to tune the colors of the emitted light. Such a feature is sometimes referred to as color drift compensation. However, this feature may also be used to set the color of the lighting device to achieve a desired color tone.

As mentioned, conventional LED drivers have limited output current capability. That is, the maximum output current per channel is rather low, typically below 100 or 200 mA. However, many lighting applications require load currents between 250 mA and 500 mA (per output channel) or even more. The embodiments described below implement a concept that allows to increase the output currents of the LED driver 40 while simultaneously maintaining the LED driver's ability to control the LEDs' (or LED chains') color based on the measured forward voltages.

FIG. 2 illustrates one exemplary embodiment of a circuit including a LED driver 40 (like in the previous example) for driving a lighting device 30 and a current amplifier circuit 43 for increasing the load current i_{L} of the lighting device 30. Only one lighting device 30 (with one or more LEDs) being connected to output channel OUT3 is shown in FIG. 2. It is understood that the same circuitry can be connected to the other output channels OUT1 and OUT2.

In the depicted example, a current detection device 45 is connected between the output node OUT3 of the LED driver 40 and the lighting device 30 (LED chain). The current detection device 45 is capable of indicating whether, or not, an output current i_{OUT} is generated by the LED driver 40 at output node OUT3. Accordingly, the current detection device 45 may be a simple diode, wherein the presence of the usual forward voltage (e.g. (approximately 0.7 V) indicates that a (non-negligible) load current I_{OUT} is passing through the diode. In some embodiments, the current detection device 45 may be capable of measuring the current, i.e. it provides a signal indicative of the output current i_{OUT}. A voltage drop across the current detection device 45 is denoted by ΔV.

The circuit of FIG. 2 further includes a current amplifier circuit 43 that is coupled to the lighting device 30 and to the current detection device 45. The current amplifier circuit 43 is configured to provide a first current i_{B} which adds to the output current i_{OUT} so that the load current i_{L} of the first lighting device 30 is the superposition of the output current i_{OUT} and the first current i_{B}. In the depicted example, the current detection device 45 is configured to activate and deactivate a current source Q_{B}, which provides the first current i_{B} dependent on whether, or not, an output current passes though the current detection device 45. For example, the current detection device 45 may provide a signal (labeled ON/OFF in FIG. 2) that enables current source Q_{B} if a non-zero output current i_{OUT} is detected and disables the current source Q_{B} if no output current is detected. In the present example, the first current i_{B} is constant. Accordingly, the output current i_{OUT} is amplified by a factor g=i_{B}/i_{OUT}. That is, i_{B}=g×i_{OUT} and the load current i_{L}=i_{OUT}×(1+g). As the amplitudes of the currents i_{OUT} and i_{B} are constant (in the present example), the factor g is constant and also the load current i_{L}. However, the output current i_{OUT} (and thus also the first current i_{B} and the load current i_{L}) may be modulated. In one example, the LED driver 40 includes a pulse-width modulator which allows to tune the average load current of the lighting device 30, while the amplitude of the load current is constant.

FIG. 3 illustrates one implementation/modification of the example of FIG. 2 in more detail. Accordingly, the circuit includes (at least) the lighting device 30, which is composed of at least one LED, and a current measurement resistor R_{S} that serves as current detection device 45. The circuit further includes a LED driver 40 that has (at least) the output terminal OUT3 coupled to the lighting device 30 via the current measurement resistor R_{S}. A current amplifier circuit 43 is coupled to the first lighting device 30 and to the first current measurement resistor R_{S} and configured to provide a first current i_{B} that is proportional to the output current i_{OUT} (i.e. i_{B}=g×i_{OUT} with a constant gain g), wherein the first current i_{B} adds to the output current i_{OUT} so that the load current i_{L} of the first lighting device 30 is the superposition of the output current i_{OUT} and the first current i_{B}. Accordingly, the load current i_{L} of the lighting device is i_{OUT}+i_{B}=(1+g)×i_{OUT}.

The voltage drop across the current measuring resistor R_{S} is denoted by ΔV, wherein ΔV=R_{S}×i_{OUT}. As the LED driver 40 “knows” the value of its output current i_{OUT}, the voltage drop ΔV is also a known parameter. Accordingly, by sensing the output voltage V_{OUT3}=V_{S}−V_{F3}−ΔV, the LED driver 40 can easily determine the forward voltage V_{F3} of the lighting device 30 (i.e. V_{F3}=V_{S}−V_{OUT3}−ΔV). The LED driver 40 may use the measured forward voltage V_{F3} to adjust the (average) output current i_{OUT} (and thus the load current respective i_{L}) in order to tune the color of the emitted light. The LED driver may either adjust the amplitude of the output current or the duty cycle of the output current in case a modulated output current is provided.

The current amplifier circuit 43 may include a difference amplifier A_{B} which receives the voltage drop ΔV across the voltage sense resistor R_{S}. The output signal of the amplifier A_{B}, which is proportional to the output current i_{OUT}, can be used to control the controllable current source Q_{B} in such a way that the current i_{B} generated by the current source Q_{B} is also proportional to the output current i_{OUT} (proportionality factor g). As a result the sum current i_{L}=i_{OUT}+i_{B}=(1+g)×i_{OUT}.

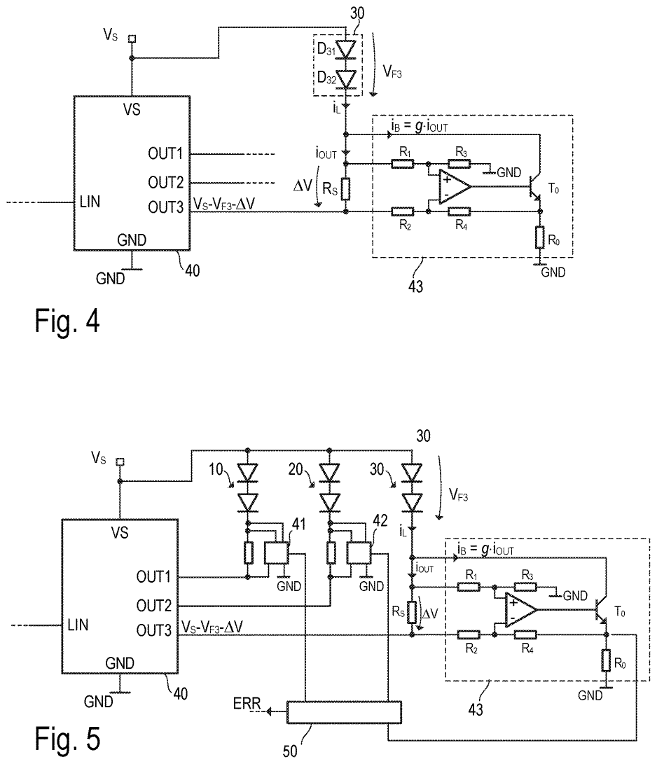

FIG. 4 illustrates an exemplary implementation of the current amplifier circuit 43 of FIG. 3 in more detail. Apart from the current amplifier circuit 43 the examples of FIGS. 3 and 4 are identical. According to FIG. 4, the difference amplifier A_{B} is implemented by an operational amplifier OA, wherein the inverting input of the operational amplifier OA is connected to the output node OUT3 of the LED driver 40 via resistor R₂ and the non-inverting input of the operational amplifier OA is connected, via resistor R₁, to the common circuit node of current sense resistor R_{S} and lighting device 30. The non-inverting input of the operational amplifier OA is further connected to ground potential via resistor R₃, and the inverting input of the operational amplifier OA is further connected, via resistor R₄, to the emitter of a transistor T₀, which acts as controllable current source. Accordingly, the base of the transistor T₀ is connected to the output of the operational amplifier OA, the emitter of the transistor T₀ is further connected to ground potential via resistor R₀, and the collector of the transistor T₀ provides the first current i_{B}. In the depicted example, the transistor T₀ is a bipolar junction transistor (BJT). It is understood that any other type of transistor (e.g. a metal-oxide-semiconductor field-effect transistor, MOSFET) may be used instead. In case of a MOSFET, the emitter is referred to as “source”.

As can be seen from FIG. 4, the voltage drop R₀×i_{B} is fed back to the inverting input of the operational amplifier OA, which will thus drive the transistor T₀ such that the emitter current i_{B} is proportional to the voltage ΔV (and thus also proportional to i_{OUT}). That is, R₀·i_{B}=A·ΔV, wherein A is the voltage gain of the difference amplifier composed of operational amplifier OA and resistors R₁ to R₄.

FIG. 5 illustrates an enhancement of the circuit of FIG. 4. The circuits of FIGS. 4 and 5 are almost identical, wherein the only difference is that FIG. 5 shows all three channels, wherein each channel includes a current amplifier circuit. Accordingly, current amplifier circuit 41 is connected to output node OUT1, and current amplifier circuit 42 is connected to output node OUT2. Moreover, the circuit of FIG. 5 includes a monitoring circuit 50, which is configured to receive the voltage drops i_{B}·R₀ (or a signal derived therefrom) from each current amplifier circuit 41, 42, and 43 and generate an error signal ERR based on these voltage drops i_{B}·R₀. For example, the monitoring circuit 50 may signal an error (e.g. to the LED driver 40 or to an external controller (not shown in the drawings) if in one or more of the circuits 41-43 the voltage i_{B}·R₀ falls below a defined threshold. In some embodiments, the error signal may indicate in which one(s) of the circuits 41-43 the voltage i_{B}·R₀ is below the threshold. Sensing the voltage drop i_{B}·R₀ across the resistors R0 allows to detect possible malfunctions of the external (external to the driver 40) LED driving circuitry.

Some examples described in the description above are summarized below. It is emphasized that the following is not an exhaustive list but only an exemplary summary. The reference numerals in brackets refer to the figures but do not limit the scope to the depicted embodiments.

Example 1: A circuit comprising: a first lighting device (30) including at least one light emitting diode (LED); a first current measurement resistor (R_{S}); a LED driver (40) having a first output terminal (OUT3) coupled to the lighting device (30) via the first current measurement resistor (R_{S}) and configured to provide an output current (i_{OUT}); a current amplifier circuit (43) coupled to the first lighting device (30) and to the first current measurement resistor (R_{S}) and configured to provide a load current (i_{L}) of the first lighting device (30) that is proportional to the output current (i_{OUT}).

Example 2: The circuit of example 1, wherein the current amplifier circuit (43) is configured to: generate an additional current (i_{B}) that is g times the output current (i_{OUT}), g being a gain value; and superpose the additional current (i_{B}) and the output current (i_{OUT}) to generate a sum current which is provided as load current (i_{L}).

Example 3: The circuit of example 3, wherein the first current measurement resistor (R_{S}) is connected between the first output terminal (OUT3) and a first circuit node, at which the additional current (i_{B}) and the output current (i_{OUT}) superpose.

Example 4: The circuit of any of examples 1 to 3, wherein the first lighting device (30) is connected to the first output terminal (OUT3) only via the first current measurement resistor (R_{S}).

Example 5: The circuit of any of examples 1 to 4, wherein the LED driver (40) is configured to adjust the output current (i_{OUT}) provided at the first output terminal (OUT3) based on a voltage present at the first output terminal (OUT3).

Example 6: The circuit of any of examples 1 to 5, wherein the LED driver (40) is configured to measure the voltage drop (V_{F3}) across the first lighting device (30) based on a voltage at the first output terminal (OUT3) and on a voltage drop (ΔV) across the first current measurement resistor (R_{S}).

Example 7: the circuit of example 6, wherein the LED driver (40) is further configured to tune a color of the light emitted by the first lighting device (30), based on the measured voltage drop (V_{F3}), by modifying the output current (i_{OUT}).

Example 8: The circuit of any of examples 1 to 5, a second lighting device (20) including at least one light emitting diode (LED) and a third lighting device (10) including at least one light emitting diode (LED), a second current measurement resistor and a third current measurement resistor, wherein the LED driver (40) has a second output terminal (OUT2) and a third output terminal (OUT1) coupled to the second lighting device (20) and the third lighting device (10) via the second current measurement resistor and the third current measurement resistor, respectively.

Example 9: The circuit of example 8, wherein a second current amplifier circuit (42) is coupled to the second lighting device (20) and to the second current measurement resistor (R_{S}) and configured to provide a load current (i_{L}) of the second lighting device (20) that is proportional to an output current (i_{OUT}) provided at the second output terminal (OUT2), and wherein a third current amplifier circuit (41) is coupled to the third lighting device (10) and to the third current measurement resistor (R_{S}) and configured to provide a load current (i_{L}) of the third lighting device (10) that is proportional to an output current (i_{OUT}) provided at the third output terminal (OUT1).

Example 10: The circuit of example 9, wherein the first, second and third lighting devices (30, 20, 10) together form a three-color LED device which is configured to emit light of a specific color; wherein the LED driver (40) is configured to adjust the color by adjusting the output currents (i_{OUT}) provided at the first, second and third output terminals (OUT3, OUT2, OUT1) based on voltages present at the first, second and third output terminals (OUT3, OUT2, OUT1).

Example 11: The circuit of any of examples 1 to 10, further comprising: a monitoring circuit (50) configured to monitor the operation of the current amplifier circuit (43) and to signal an error signal in the event that the current amplifier does not operate properly.

Example 12: The circuit of any of examples 1 to 11, wherein the LED driver (40) is configured to generate, as the output current (i_{OUT}), a modulated current having a constant amplitude and an adjustable duty cycle.

Example 13: The circuit of example 9 or 10, wherein the output currents (i_{OUT}) provided by the LED driver (40) are modulated currents having an amplitude and an adjustable duty cycle, and wherein the LED driver (40) is configured to adjust the color by adjusting the duty cycles of the output currents (i_{OUT}) provided at the first, second and third output terminals (OUT3, OUT2, OUT1).

Example 14: A circuit comprising: a first lighting device (30) including at least one light emitting diode (LED); a first current detection device (45); a LED driver (40) having a first output terminal (OUT3) coupled to the lighting device (30) via the first current detection device (45) and configured to provide an output current (i_{OUT}); and a current amplifier circuit (43) coupled to the first lighting device (30) and to the first current detection device (45) and configured to provide a first current (i_{B}) which adds to the output current (i_{OUT}) so that a load current (i_{L}) of the first lighting device (30) is the superposition of the output current (i_{OUT}) and the first current (i_{B}).

Example 15: The circuit of example 14, wherein the current amplifier circuit (43) includes a current source (Q_{B}) configured to generate the first current (i_{B}) dependent on a control signal; and wherein the current detection device (45) is configured to provide the control signal for the current source (Q_{B}) dependent on the output current (i_{OUT}), which passes though the current detection device (45).

Example 16: The circuit of example 15, wherein the control signal indicates whether, or not, the current detection device (45) detects a current passing through it; and wherein the current source (Q_{B}) is configured to be activated or deactivated in accordance with the control signal.

Example 17: The circuit of example 14 or 15, wherein the current detection device (45) is a current measuring resistor (R_{S}).

Example 18: The circuit of example 17, wherein the current amplifier circuit (43) is configured to provide, as the first current (i_{B}), a current that is proportional to the voltage drop (ΔV) across the current measuring resistor (R_{S}).

Example 19: The circuit of example 17, wherein the current amplifier circuit (43) includes a current source (Q_{B}) configured to generate the first current (i_{B}) dependent on a control signal; and wherein the current amplifier circuit (43) includes an amplifier (A_{B}) configured to receive an input signal representing a voltage drop (ΔV) across the current measuring resistor (R_{S}) and to provide, as output signal, the control signal.

Example 20: The circuit of any of examples 14 to 19, wherein the LED driver (40) is configured to measure the voltage drop (V_{F3}) across the first lighting device (30) based on a voltage at the first output terminal (OUT3) and on a voltage drop (ΔV) across the first current detection device (45).

Example 21: the circuit of example 20, wherein the LED driver (40) is further configured to tune a color of the light emitted by the first lighting device (30), based on the measured voltage drop (V_{F3}), by modifying the output current (i_{OUT}).

Example 22: The circuit of any of examples 14 to 21, wherein the first lighting device (30) is coupled to the first output terminal (OUT3) of the LED driver (40) via only the first current detection device (45).

Example 23: The circuit of any of examples 14 to 22, a second lighting device (20) including at least one light emitting diode (LED) and a third lighting device (10) including at least one light emitting diode (LED), a second current detection device and a third current detection device, wherein the LED driver (40) has a second output terminal (OUT2) and a third output terminal (OUT1) coupled to the second lighting device (20) and the third lighting device (10) via the second current detection device and the third current detection device, respectively, wherein the first, second and third lighting devices (30, 20, 10) together form a three-color LED device which is configured to emit light of a specific color tone.

Example 24: The circuit of example 23, wherein the output currents (i_{OUT}) provided at the output terminals (OUT3, OUT2, OUT1) of the LED driver (40) are modulated currents having an amplitude and an adjustable duty cycle, and wherein the LED driver (40) is configured to adjust the color tone by adjusting the duty cycles of the output currents (i_{OUT}) provided at the first, second and third output terminals (OUT3, OUT2, OUT1).

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond-unless otherwise indicated-to any component or structure, which performs the specified function of the described component (e.g., that is functionally equivalent), even though not structurally equivalent to the disclosed structure, which performs the function in the herein illustrated exemplary implementations of the invention.

1. A circuit comprising:
a first lighting device including at least one light emitting diode;
a first current measurement resistor;
a LED driver comprising a first output terminal coupled to the lighting device via the first current measurement resistor and configured to provide an output current;
a current amplifier circuit coupled to the first lighting device and to the first current measurement resistor and configured to provide a load current of the first lighting device that is proportional to the output current.

2. The circuit of claim 1, wherein the current amplifier circuit is configured to:
generate an additional current that is g times the output current, g being a gain value; and
superpose the additional current and the output current to generate a sum current which is provided as load current.

3. The circuit of claim 2,
wherein the first current measurement resistor is connected between the first output terminal and a first circuit node, at which the additional current and the output current superpose.

4. The circuit of claim 1,
wherein the first lighting device is connected to the first output terminal only via the first current measurement resistor.

5. The circuit of claim 1,
wherein the LED driver is configured to adjust the output current provided at the first output terminal based on a voltage present at the first output terminal.

6. The circuit of claim 1,
wherein the LED driver is configured to measure a voltage drop across the first lighting device based on a voltage at the first output terminal and on a voltage drop across the first current measurement resistor.

7. The circuit of claim 6,
wherein the LED driver is further configured to tune a color of the light emitted by the first lighting device, based on the measured voltage drop across the first lighting device, by modifying the output current.

8. The circuit of claim 1,
a second lighting device including at least one light emitting diode and a third lighting device including at least one light emitting diode;
a second current measurement resistor and a third current measurement resistor;
wherein the LED driver comprises a second output terminal and a third output terminal coupled to the second lighting device and the third lighting device via the second current measurement resistor and the third current measurement resistor, respectively.

9. The circuit of claim 8,
wherein a second current amplifier circuit is coupled to the second lighting device and to the second current measurement resistor and configured to provide a load current of the second lighting device that is proportional to an output current provided at the second output terminal, and
wherein a third current amplifier circuit is coupled to the third lighting device and to the third current measurement resistor and configured to provide a load current of the third lighting device that is proportional to an output current provided at the third output terminal.

10. The circuit of claim 9,
wherein the first, second and third lighting devices together form a three-color LED device which is configured to emit light of a specific color;
wherein the LED driver is configured to adjust the specific color by adjusting the output currents provided at the first, second and third output terminals based on voltages present at the first, second and third output terminals.

11. The circuit of claim 1, further comprising:
a monitoring circuit configured to monitor the operation of the current amplifier circuit and to signal an error signal in the event that the current amplifier does not operate properly.

12. The circuit of claim 1,
wherein the LED driver is configured to generate, as the output current, a modulated current having a constant amplitude and an adjustable duty cycle.

13. The circuit of claim 10,
wherein the output currents provided by the first, second, and third output terminals of the LED driver are modulated currents having an amplitude and an adjustable duty cycle, and
wherein the LED driver is configured to adjust the specific color by adjusting the duty cycles of the output currents provided at the first, second and third output terminals.

14. A circuit comprising:
a first lighting device including at least one light emitting diode (LED);
a first current detection device;
a LED driver having a first output terminal coupled to the lighting device via the first current detection device and configured to provide an output current ;
a current amplifier circuit coupled to the first lighting device and to the first current detection device and configured to provide a first current which adds to the output current so that a load current of the first lighting device is the superposition of the output current and the first current

15. The circuit of claim 14,
wherein the current amplifier circuit includes a current source configured to generate the first current dependent on a control signal; and
wherein the current detection device is configured to provide the control signal for the current source dependent on the output current, which passes though the current detection device.

16. The circuit of claim 15,
wherein the control signal indicates whether, or not, the current detection device detects a current passing through the current detection device; and
wherein the current source is configured to be activated or deactivated in accordance with the control signal.

17. The circuit of claims 14,
wherein the current detection device is a current measuring resistor

18. The circuit of claim 17,
wherein the current amplifier circuit is configured to provide, as the first current, a current that is proportional to a voltage drop across the current measuring resistor

19. The circuit of claim 17,
wherein the current amplifier circuit includes a current source configured to generate the first current dependent on a control signal; and
wherein the current amplifier circuit includes an amplifier configured to receive an input signal representing a voltage drop across the current measuring resistor and to provide, as an output signal, the control signal.

20. The circuit of claim 14,
wherein the LED driver is configured to measure a voltage drop across the first lighting device based on a voltage at the first output terminal and on a voltage drop across the first current detection device.

21. The circuit of claim 20,
wherein the LED driver is further configured to tune a color of the light emitted by the first lighting device based on the measured voltage drop across the first lighting device, by modifying the output current.

22. The circuit of claim 14,
wherein the first lighting device is coupled to the first output terminal of the LED driver via only the first current detection device.

23. The circuit of claim 14, further comprising:
a second lighting device including at least one LED and a third lighting device including at least one LED,
a second current detection device and a third current detection device, wherein the LED driver comprises a second output terminal and a third output terminal coupled to the second lighting device and the third lighting device via the second current detection device and the third current detection device, respectively,
wherein the first, second and third lighting devices together form a three-color LED device which is configured to emit light of a specific color tone.

24. The circuit of claim 23,
wherein the output currents provided at the output terminals of the LED driver are modulated currents having an amplitude and an adjustable duty cycle, and
wherein the LED driver is configured to adjust the specific color tone by adjusting the duty cycles of the output currents provided at the first, second and third output terminals.
